(19) United States
(12) Patent Application Publication
(10) Pub. No.: US 2026/0295440 A1
(43) Pub. Date: Oct. 1, 2026

(54) SYSTEMS AND METHODS FOR PROVIDING MODIFIED VIRTUAL ENVIORNMENTS

(71) Applicant: Electronic Arts, Inc., Redwood City, CA (US)

(72) Inventors: Danillo Abreu, Maple Ridge (CA); Michael David Jones, Vancouver (CA); Breno Leao, Burnaby (CA); Sorin-Mihail Georgescu, Bucharest (RO); Viet Hoang, Vancouver (CA); Evan Williams, Vancouver (CA)

(73) Assignee: Electronic Arts, Inc., Redwood City, CA (US)

(21) Appl. No.: 19/095,793

(22) Filed: Mar. 31, 2025

(51) Int. Cl. A63F 13/812; A63F 13/52

(52) U.S. Cl. CPC A63F 13/812; A63F 13/52

(57) ABSTRACT

An application (e.g., corresponding to a video game) may generate a virtual game environment including various virtual character models (e.g., a player virtual character model and an opponent virtual character model, also referred to herein as a “player model” and an “opponent model”). The application can generate a virtual environment that includes a field sized according to a count of player models. The application can determine a state of the virtual environment based on a user input. Using the state, the application can identify an assignment for each player model to direct the player models to a portion of the playable field. The application can modify the assignment of each player model based on subsequent inputs by the user.

### FIELD OF DISCLOSURE

The present disclosure is generally related to applications, including but not limited to, systems and methods for modifying a virtual environment.

### BACKGROUND

Demand for ever increasing realism and detail in computer-implemented virtual environments, such as video games, drives the growth of computer performance. However, computer-implemented video games that include various central processing unit (CPU) controlled players with a minimal number of human controlled players, often have increased processing power, increased latency, significant AI processing, increased computational load, among others due to the management of game logic and decision matrices. It can be difficult to maintain a virtual game environment utilizing various CPU controlled players while modifying a virtual game environment. therefore, it can be difficult to maintain a modified virtual game environment while allowing for the fluid interaction between human controlled players and CPU controlled players.

### SUMMARY

In one aspect, this disclosure can be directed to a system, including a data store, and a processing circuit. The data store may include application data. The processing circuit can include one or more processors configured to execute an application based on the application data. The one or more processors can be configured to generate a virtual environment having a field sized according to a count of a plurality of virtual character models which are configured for control within the field. The one or more processors can be configured to determine a first state of the virtual environment based on at least one of a user input, a location of each virtual character model with the field, or the location of a target object proximal to each virtual character model within the field. The one or more processors can be configured to identify an assignment for each virtual character model according to the first state of the virtual environment, the assignment indicating a portion of the field for each virtual character model. The one or more processors can be configured to receive a second user input for movement of at least one virtual character model to the portion of the field within the virtual environment. The one or more processors can be configured to responsive to modifying the first state of the virtual environment to a second state, update the assignment of each virtual character model based on the movement of the at least one virtual character model of the plurality of virtual character models.

The one or more processors can configure a weight for assignment of each virtual character model based on whether a respective virtual character model can be user-controlled or a non-user controlled. The field has a length and a width. The length can be reduced at a first ratio according to a reduction in the count of virtual character models and the width can be reduced at a second ratio. The first ratio can be greater than the second ratio. When the count is five, the first ratio and the second ratio can be between 39% and 42%. The one or more processors can be configured to generate, according to the first state, an overlay within the field indicating the portion of the field for the at least one virtual character model to occupy based on the assignment.

The one or more processors can be configured to detect a change to a user status and automatically implement one or more controls to a first virtual character model in control by a user, responsive to the change in the user status. The one or more processors can be configured to select, from a set of predefined actions, a first action for implementing the one or more controls of the first virtual character model, to implement limited non-user control responsive to the change in the user status. The one or more processors can be configured to generate an indicator relative to the user to indicate the user status, responsive to the change in the user status. The one or more processors can be configured to provide the indicator for display proximal to the first virtual character model in the virtual environment.

The one or more processors can be configured to receive a third user input indicating a command corresponding to a prompt relative to a first virtual character model. The one or more processors can be configured to display an overlay including the prompt, adjacent to the first virtual character model, and visible to one or more other users in the virtual environment. The third user input can be to a selectable field including a subset of a plurality of prompts. Each prompt in the subset of prompts selected from the plurality of prompts based on the first state or the second state. The one or more processors can be configured to identify a second assignment for each virtual character model according to the second state of the virtual environment. The second assignment indicating a second portion of the field for each virtual character model. The one or more processors can be configured to receive a third user input for movement of at least one virtual character model to the second portion of the field within the virtual environment. The one or more processors can be configured to responsive to modifying the second state of the virtual environment to a third state, update the second assignment of each virtual character model based on the movement of at least one virtual character model according to the third user input.

In another aspect, this disclosure relates to a computer-implemented method executable by a user computing device for executing a application. The method can include generating, by one or more processors, a virtual environment having a field sized according to a count of a plurality of virtual character models which are configured for control within the field. The method can include determining, by the one or more processors, a first state of the virtual environment based on at least one of a user input, a location of each virtual character model with the field, the location of a target object proximal to each virtual character model within the field. The method can include identifying, by the one or more processors, an assignment for each virtual character model according to the first state of the virtual environment. The assignment indicating a portion of the field for each virtual character model. The method can include receiving, by the one or more processors, a second user input for movement of at least one virtual character model to the portion of the field within the virtual environment. The method can include responsive to modifying the first state of the virtual environment to a second state, updating, by the one or more processors, the assignment of each virtual character model based on the movement of the at least one virtual character model of the plurality of virtual character models.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is a block diagram of a networked computing environment for implementing one or more embodiments of a video application, according to an example implementation of the present disclosure.

FIG. 2 is an example of a virtual environment including a playable field, according to an example implementation of the present disclosure.

FIG. 3 is an example of the playable field with a plurality of players in a first state, according to an example implementation of the present disclosure.

FIG. 4 is an example of the playable field including a message overlay for at least one player in a second state, according to an example implementation of the present disclosure.

FIG. 5 is an example of the playable field with a plurality of players in a third state, according to an example implementation of the present disclosure.

FIG. 6 is a flowchart showing an example method of providing modified virtual environments, according to an example implementation of the present disclosure.

FIG. 7 is a flowchart showing an example method of assigning non-user controlled player models, according to an example implementation of the present disclosure.

FIG. 8 is a flowchart showing an example method of generating overlays for the virtual environment, according to an example implementation of the present disclosure.

FIG. 9 illustrates an example embodiment of a computing device, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

The systems and methods described herein relate to modifying virtual environments, within the context of video game applications (hereinafter “video applications”, “video games”, or application in short). Video games can experience degradation in performance when utilizing many CPU controlled players, as CPU controlled players may be multi-threaded, thereby using significant computing resources to operate and maintain such CPU controlled players. According to the systems and methods described herein, an application (e.g., corresponding to a video application) may generate a virtual environment including various virtual character models (e.g., a player virtual character model and an opponent virtual character model, also referred to herein as a “player model” and an “opponent model”). The application can generate a virtual environment that includes a field sized according to a count of player models. The application can determine a state of the virtual environment based on a user input. Using the state, the application can identify an assignment for each player model to direct the player models to a portion of the playable field. The application can modify the assignment of each player model based on subsequent inputs by the user. In this manner, the systems and methods described herein can implement a graphics processing unit (GPU) controlled player, thereby provided a more fluid and streamlined experience while reducing the computational load of CPU controlled players.

Utilizing the systems and methods described herein a video game can provide optimal assignments for the CPU controlled players by updating states of the video game based on movements by the player models. The systems and methods described herein can allow for adaptive gameplay logic in reduced field size implementations. The gameplay logic of the player models may not conform with logic programed with or trained on (i.e., for a field of a larger/standard size). This occurs due to (i) the new field lines and (ii) the new placement mechanic that set players in certain positions are detected. The systems and methods described herein mitigate the discrepancies from the original logic to revised logic to conform to modified field sizes, so that player logic is maintained accordingly. Additionally, the use of ML players (e.g., GPU-controlled players) for gameplay can inherently address some of these concerns by being more contextually aware of smaller field sizes and smaller team sizes.

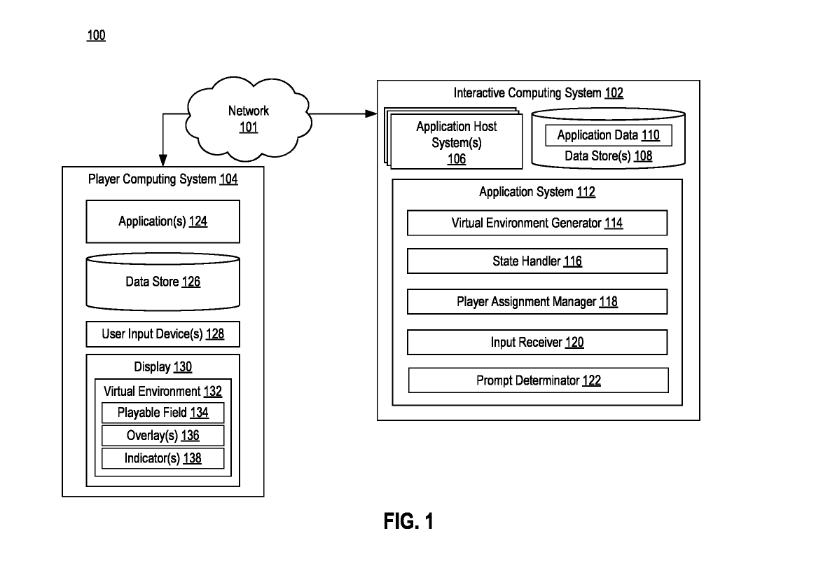

FIG. 1 is a block diagram of a networked computing environment 100 for implementing one or more embodiments of a video application. The network computing environment 100 is shown to include an interactive computing system 102 communicably coupled to a player computing system 104 via a network 101. While FIG. 1 illustrates one interactive computing system 102 and one player computing system 104, it is noted that the networked computing environment 100 may include multiple instances of the interactive computing system 102 and/or multiple player computing systems 104. The interactive computing system 102 may be or include a computing system or environment which hosts, provisions, provides, manages, or otherwise supports one or more applications. The interactive computing system 102 may include one or more application host systems 106, a data store 108, and a application system 112. The application system 112 can include a virtual environment generator 114, a state handler 116, player assignment manager 118, an input receiver 120, and a prompt determinator 122.

The network 101 may be or include any type or form of wired or wireless communication network to facilitate communication between two or more endpoints. For example, the network 101 may include a cellular or internet-based network. Additionally, the player computing system 104 and/or interactive computing system 102 may use a corresponding local network. For example, the player computing system 104 may be communicably coupled to a local area network (such as a wireless local area network, e.g., WI-FI). In this example, communications sent from the player computing system 104 (and conversely, received by the player computing system 104) may be routed via the local area network.

The interactive computing system 102 may include application host system(s) 106, a data store 108 that includes application data 110 to render the application 124, and a application system 112. These systems may cooperate or otherwise communicate with one another, as part of providing various portions of the virtual environment 132 described herein. For example, the application system 112 may obtain data associated with the application 124 from the application host system(s) 108, and retrieve data corresponding to virtual character models, player assignments, etc. from the data store 108. Additionally, the application system 112 may receive user inputs (e.g., from the user input device 128) for interacting within the virtual environment 132 of the application 124. In some embodiments, the application host system(s) 106 may communicate with the data store 108 to execute/provision/host the application 124. In some embodiments, the interactive computing system 102 may be associated with a network-based service, which may be operated or managed by a publisher, software developer, platform provider, or other host entity.

The application host system(s) 106 may be configured to execute a portion of the application 124 operating on the player computing system 104, a host application or resource, or any other application or service of the interactive computing system 102. In various embodiments, the interactive computing system 102 may be configured to facilitate multiple players or player computing systems 104 accessing a portion (or instance) of the application 124. In some embodiments, the portion of the application 124 executed by application host system(s) 106 may create a persistent virtual environment. The persistent virtual environment may facilitate interaction amongst players in a synchronous and/or asynchronous manner. In some cases, multiple instances of the persistent virtual environment may be established, hosted, or otherwise managed by the interactive computing system 102 (e.g., through execution by the application host system(s) 106). For example, the application host system(s) 108 and/or interactive computing system 102 may be configured to assign a set of players (or player computing systems 104) to one instance of the persistent virtual environment for access, while assigning another set of players (or player computing systems 104) to another instance of the persistent virtual environment for access.

In some embodiments, the application host system(s) 106 may execute a hosting system for executing various aspects of a virtual environment. For example, in one embodiment, the application 124 may be a competitive game, such as a sports game, and the application host system 106 may provide a dedicated hosting service for hosting multiplayer game instances. As another example, the application host system 106 may be configured to facilitate the creation of game instances hosted by player computing systems 104. In some embodiments, the application host system(s) 106 may provide a lobby or other environment for players to virtually interact with one another.

The interactive computing system 102 may include one or more data stores 108. The data store 108 may be configured to store data acquired by other systems, such as, for example, telemetry data, video data, user interface state information, user data, character data or metrics, or the like. In some embodiments, the data store 108 may store user profile data associated with a video application publisher, a platform provider or other service. In such an example, the user profile data may be deployed, provisioned, or otherwise provided by the interactive computing system 102 to the player computing system 104 (e.g., at log-in), which facilitates user-maintained preferences, progress, customization information, and/or other data across a plurality of different video applications and player computing systems 104. The data store 108 may be distributed across multiple computing systems (such as multiple interactive computing systems 102). In some embodiments, the data store 108 may be network-based storage system where data may be stored in different locations. The data store can house or maintain application data 110 accessible by the player computing system 104.

The application system 112 can include one or more processors (e.g., virtual environment generator 114, state handler 116, player assignment manager 118, input receiver 129, prompt determinator 122) that are designed or configured to execute or otherwise perform various functions relating to the virtual environment 132 described herein. While these processors are shown and described herein, it is noted that fewer and/or alternative engines may be incorporated into the application system 112. For example, one or more of the processors may be divided into multiple processors. Additionally, or alternatively, two or more of the processors may be combined into a single processor.

The application system 112 may be configured to provide information, data, and the like for generating, rendering, displaying, updating, animating, or otherwise providing the virtual environment 132.

The player computing system 104 may include, execute, run, or otherwise provide one or more applications 124. The player computing system 104 may be configured to communicate (e.g., via the network 101) with the application host system(s) 106 to download/upload or otherwise exchange information relating to the application(s) 124 provided by the player computing system 104. Such information may be stored or otherwise maintained by a data store 126 of the player computing system 104, uploaded for storage at the data store 108 at the interactive computing system 102, etc.

The player computing system 104 may include a data store 126. The data store 126 may be configured to store data associated with one or more applications 124, local account data associated with an account maintained for the player by the interactive computing system 102, and/or other game-related or account-related data. For example, the data store 126 may be configured to store data associated with user preferences, custom virtual characters or teams of virtual characters playable within the virtual environment 132, customized or updated character metrics 214, and so forth. Such information may be used by the player computing system 104 and/or interactive computing system 102 for providing and/or updating the virtual environment 132.

In further detail, the player computing system 104 may be configured to be controlled by/interacted with a user, such as a player of a video application via a user input device 128. The user input device 128 can include or may be equipped with software and hardware to interact with a virtual environment 132. The user input device 128 can be a keyboard and mouse, a joystick, a touch screen (e.g., via a tablet, smartphone, virtual reality, etc.), motion controllers, a multi-button controller, a gamepad, among others. The user input device 128 can be communicably coupled (e.g., via Bluetooth, wired connection, NFC, Wi-Fi) to the display 130 or the player computing system 104.

The player computing system 104 may include hardware and software components for establishing communications over the network 101. For example, the player computing system 104 may be equipped with networking equipment and network software applications (for example, a web browser) that facilitates communications via one or more networks 101 (for example, the Internet or an intranet). The player computing system 104 may have varied local computing resources such as central processing units and architectures, memory, mass storage, graphics processing units, communication network availability and bandwidth, and so forth. The player computing system 104 may include any type of computing system. For example, the player computing system 104 may include any type of computing device(s), such as desktops, laptops, game application platforms, virtual reality systems, augmented reality systems, television set-top boxes, televisions (for example, Internet TVs), network-enabled kiosks, car-console devices computerized appliances, wearable devices (for example, smart watches and glasses with computing functionality), and wireless mobile devices (for example, smart phones, PDAs, tablets, or the like), to name a few.

The player computing system 104 may be configured to execute one or more applications 124. Such applications 124 may be stored and/or executed locally and/or in a distributed environment. In a locally executed application 124, generally, the application may not rely on or utilize an external computing system (for example, the interactive computing system 102) to execute the application. In some instances, a locally executable application may communicate with an external server (such as a server of the interactive computing system 102) to retrieve information associated with the application, such as game patches, game authentication, clouds save, user account data, user customization information, or other features. In distributed applications, the player computing system 104 may execute a portion of an application and the interactive computing system 102 (or an application host system 106 of the interactive computing system 102) may execute another portion of the game. For instance, the application may include a client portion executed by the player computing system 104 and a server portion executed by one or more application host systems 106. For the present discussion, the type of application 124 may be a locally executable game, a distributed application, or an application that includes a portion that executes on the player computing system 104 and a portion that executes on at least one of the application host systems 106. It should be understood that, in instances in which the application 124 is a locally executable game, the application system 112 described above (and features/elements/hardware corresponding thereto, including certain information retrieved from the data store(s) 110 and/or generated by the application host system(s) 106) may be executed and/or stored locally.

The player computing system 104 may include or be communicably coupled with a display 130 configured to render, display, or otherwise provide the virtual environment 132 that include a playable field 134, one or more overlays 136, and one or more indicators 138. The playable field 134 can a be a sports field (e.g., soccer field, football field, basketball court, hockey rink, etc.) that maintains a target number of player models according to the application 124. The overlays 136 can be one or more graphical user interface element that appear in various portions of the display 130 (e.g., top, bottom, side). The overlays 136 can include a plurality of information (e.g., messages, status, arrows) that is communicated to the player models. The indicators 138 can be an indication, a flag, a marker, or another type of indicator to convey a status to the user

The display 130 may be or include any type or form of display, including a light emitting diode (LED) display, an organic-LED (OLED) display, liquid crystal display (LCD), plasma display, or any other type or form of display, which may be integrated into the player computing system 104 or a standalone display (such as a monitor or television) communicably coupled to the player computing system 104. The player computing system 104 may include one or more user input device(s) 128 for receiving user interactions for navigating/selecting/interacting with the virtual environment 132. The user input device(s) 128 may include, for example, a handheld controller, touchpad, a keyboard, a mouse, a joystick, stylus, gesture recognition sensor, or any other type/form of input device.

The virtual environment 132 may include various virtual character models, some of which may be user-controlled (e.g., player-controlled virtual character models) and others of which may be non-player characters (e.g., computer or application 124 controlled virtual character models). The application system 112 may be configured to collect various real-time and character model related data (e.g., location within the playable field 134, movement) and during game play and use those for player assignments and adjusting overlays 136 which are related to the virtual environment 132.

The game application system can include a virtual environment generator 114. The virtual environment generator 114 can be configured to generate, create, or otherwise determine a virtual environment 132 for the player computing system 104. the virtual environment generator 114 can be configured to identify one or more features to generate the virtual environment according to the application data 110. The one or more features can correspond to user inputs or selections on the display 130. For example, the virtual environment 132 can include a playing field, a training field, a tutorial environment, a waiting screen, a lobby, among other virtual environments 132, according to the one or more features. The virtual environment generator 114 can generate or otherwise determine a field 134 for display within the virtual environment 132. The field can be a playable field. In the context of soccer, the virtual environment generator 114 can generate turf, guidelines, goalposts, fans, referees, among other aspects of a soccer game environment. The playable field 134 can be housed within the data store 108 such that the virtual environment generator 114 extracts the playable field 134 from the data store 108. In some instances, the data store 108 can house a framework or instructions to generate the playable field.

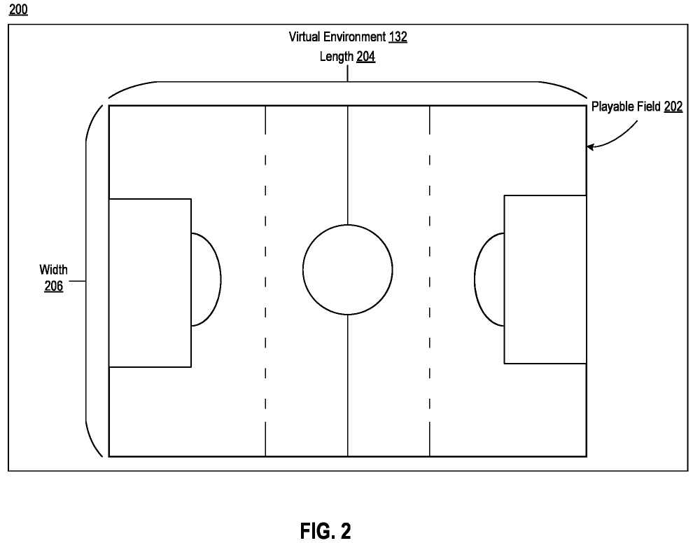

Referring to FIG. 1 and FIG. 2, depicted is an example 200 of a virtual environment 132 including the playable field 202 (e.g., playable field 134). The virtual environment generator 114 can access the data store 108 to extract a model or framework of a playable field 134 that include the one or more features. For instance, the data store 108 can include the grass texture, the lines, the goalposts, the dimensions of the playable field, among others. The virtual environment generator 114 can use the application data 110 to determine realistic lighting, shading, weather, turf conditions, among others to provide a fluid and realistic playable field 134.

The virtual environment generator 114 can generate the playable field 134 to include a length 204 and a width 206. The length 204 and width 206 can be a distance or measurement to form the boundary of the playable field 134. The playable field 134 can include the same format as, for instance, a soccer field, a football field, a basketball court, etc. However, and according to some game application modes, the playable field 134 can be a reduced size in comparison to the actual field in real life. For example, and according to a game application mode for the application 124, a soccer field in the virtual environment 132 can be a reduced size in comparison to a soccer field in a different game application mode for the application 124.

The virtual environment generator 114 can generate the playable field 134 to include a size that is determined, derived, or generated based on the count of the virtual character models ( referred to as “player models”). In some embodiments, to generate the playable field 134 according to the count of player models, the virtual environment generator 114 may be configured to retrieve a first size of a playable field 134 (e.g., having a first width and first length). The first size may be a fixed size according to, e.g., a stadium or location selected by users, for a first count of player models (e.g., 11 player models per team). In some embodiments, different stadiums or different locations may have different first sizes of playable fields 134. The virtual environment generator 114 may be configured to modify the first size, by reducing he first length and first width, according to a count of player models selected for interaction within the virtual environment. For example, and in this regard, a playable field 134 that holds six player models per team can be smaller than a playable field that holds 11 player models per team. The length 204 can be reduced at a first ratio (e.g., relative to the length of the first size of the playable field 134) based on a reduction in the count of the player models. For example, the virtual environment generator 114 can include 12 player models (e.g., six player models per team) and can reduce the length 204 to form a dimension of the playable field. Similar to the length 204, the width 206 of the playable field 134 can be reduced at a second ratio (e.g., relative to the width of the first size of the playable field 134). In some embodiments, the ratio for the length 204 can be greater than the ratio of the width 206. In some instances, the first ratio and the second ratio are between 39% and 42% of the length and width of the first size, when the count of player models is five per team. As the count of player models increases, the first and second ratios can correspondingly increase (e.g., to provide a larger sized field, while still reduced from the first size, based on the count of player models being less than 22). Using the length 204 and the width 206 of the modified size for the playable field, the virtual environment generator 114 can generate the playable field 134 for the virtual environment 132. The virtual environment generator 114 can embed one or more instructions into a data packet to render the playable field 134 at the virtual environment 132.

The application system 112 can include a state handler 116 to determine, identify, or otherwise indicate a state of the virtual environment. The state can correspond or refer to a condition, a situation, a point in time, or a status among other states. The state handler 116 can determine the state based on a plurality of factors. For example, the state handler 116 can determine the state of the virtual environment 132 based on a user input, in another example, the state handler 116 can determine the state of the virtual environment 132 based on a location of each player model with the playable field 134. The location of each player model can be in any portion of the playable field 134. In another example, the state handler 116 can determine the state of the virtual environment 132 based the location of a target object proximal to each player model within the playable field 134. The target object can be a graphical representation of a soccer ball, a basketball, a hockey puck, among other forms of target objects.

The state handler 116 can update the state at multiple instances during a game played on the playable field 134. For example, a player model in a first location can correspond to a first state of the virtual game environment 132. As the player model moves to a second location in the playable field 134, the state handler 116 can update or modify the first state to a second state. In the context of soccer, the target object can be a soccer ball. As the target object is in possession by a player model, the state handler 116 can determine a first state for the virtual environment 132. As and after the player model passes the target object, the state handler 116 can modify the first state to a second state for the virtual environment 132. In some instances, the input receiver 120 can detect, monitor, or otherwise identify user inputs from the user input devices 128 an transmit the user input or the indication of the user input to the state handler 116.

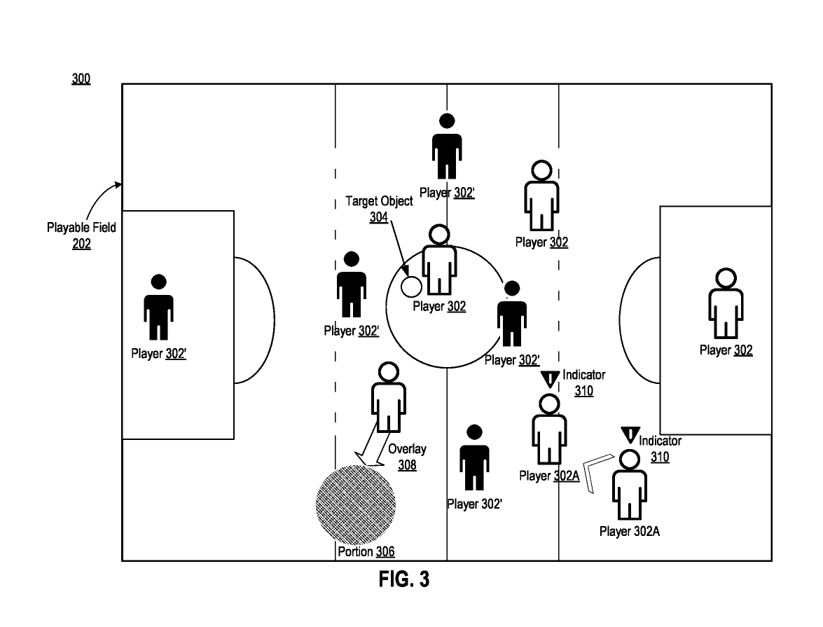

Referring now to FIG. 1 and FIG. 3, depicted is an example of the playable field 134 with the plurality of player models (e.g., player models 302 and player models 302’) in a first state 300. FIG. 3 is depicted as showing five player models 302 on a first team, and five player models 302’ on a second team. The first state 300 can include locations of each of the player models 302 within the playable field 134, including a player model 302 in close proximity (or in possession) of the target object 304 (e.g., soccer ball). Each of the player models 302 can be located at a portion 306 of the playable field 134. The portion 306 can be any location within the playable field that is not occupied by at least one player model 302. In some instances, the portion 306 can be proximal to the target object 304 if the player model 302 is on defense. In some instances, the portion 306 can be distal from the target object 304 if the player model 302 is on offense. The portion 306 can be a shape, such as a circle, a square, a rectangle, an ellipse, among other shapes.

In the context of the first state 300, the player assignment manager 118 can assign, indicate, or otherwise identify a player assignment for each player model 302 according the first state 300 of the virtual environment 132. The assignment can correspond to a position of the payer model 302, a location of the player model 302, an optimal location of the player model 302. The position of the player model 302 can include at least one of a goalkeeper, center back, a full back, a wing back, an attacking midfielder, a wide midfielder, a central midfielder, a striker, a center forward, a winger, among other positions. The player assignment manager 118 can determine the position of the player model 302 on the team in possession of the target object 304, the location of the player model 302, a formation of the player models 302, among other factors. For example, a first player 302 can be in possession of the target object 304, thereby the player assignment manager 118 can assign the first player 302 as a striker. However, a second player 302’ on the opposing team that is the furthest away from the target object 304 can be assigned as the goalkeeper.

The player assignment manager 118 can identify the player assignment for each player model 302. The player assignment can be based on the location of the player model 302. For example, a first player model 302 on a team that is not in possession of the target object 304, can be located towards the center of the playable field 134. Based on the location, the player assignment manager 118 can assign the first player as a center back. In another example, the first player model 302 on a team that is not in possession of the target object 304, can be located in the right side of the playable field 134. Based on the location, the player assignment manager 118 can assign the first player model 302 as a full back. In some instances, the player assignment manager 118 can configure, assign or otherwise indicate a weight for the player assignment of the player models 302. The weight can be a metric, a value, an indication, or a parameter that is based on whether the player model 302 is user-controlled or non-user controlled (e.g., CPU controlled).

The player assignment can indicate the portion 306 of the playable field 134 for at least one player model 302. To direct the at least one player model 302 to the portion 306, the player assignment manager 118 can generate, create, or otherwise determine an overlay 308 (e.g., overlay 136 of FIG. 1) for display on the playable field 134. The overlay 308 can include one or more user interface elements that are rendered on the display 130. The one or more user interface elements can include a shape to guide the at least one player model 302 to the portion 306 of the playable field 134. As shown in FIG. 3, the shape can include a single array, a plurality of arrows, a ray, a line, among other shapes to provide direction. For example, a first player 302 can be in front of a second player 302 in possession of the target object 304 in the first state 300. The player assignment manager 118 can identify the first player 302 as the left winger. The player assignment manager 118 can generate the overlay 308 to direct the first player model 302 to a portion 306 of the playable field 134 to be established at the left winger.

In some embodiments, the overlay 308 may only be displayed to one instance of the virtual environment (e.g., to display the overlay 308 to a user which is controlling or otherwise interacting with the first player model 302). In this regard, the player assignment manager 118 may be configured to forego displaying of the overlay 308 on other instances of the virtual environment, while maintaining the overlay 308 for an instance of the virtual environment which corresponds to receipt of inputs for control of the player model 302 that is associated with the overlay 308.

In some embodiments, the player assignment manager 118 may be configured to determine which of a plurality of overlays to display. For example, the player assignment manager 118, at any given state, may determine a plurality of overlays for a plurality of player models 302. The player assignment manager 118 may be configured to determine a weight/score for each of the plurality of overlays, which may be based on predicted impact to the virtual environment, predicted outcome or subsequent state, and so forth. In some embodiments, the player assignment manager 118 may be configured to apply a given state to a scoring model (e.g., a machine learning model or other modeling system) which generates scores for different overlays. The scoring model may be configured or trained to generate the score using, e.g., reinforcement learning, Monte Carlo tree search, a neural network, advantage actor-critic model, etc., according to a best outcome for the next state. The player assignment manager 118 may be configured to select the overlay 308 in which to display, from the plurality of overlays, based on the score of the overlays (e.g., select the overlay 308 having the greatest score).

In some embodiments, the player assignment manager 118 may be configured to initiate a timer responsive to display of an overlay 308. For example, the player assignment manager 118 may be configured to display the overlay 308 for a limited duration (e.g., two seconds), where the overlay 308 is removed from the virtual environment responsive to expiry of the timer. In some embodiments, the player assignment manager 118 may be configured to limit a count of overlays 308 displayed to users of the virtual environment, according to a game mode. For example, the player assignment manager 118 may be configured to limit display of overlays 308 to be N number overlays for a given time period, one overlay every N minutes of play, etc. (where N may be reduced, in some implementations to 0, based on a selected game mode). In this regard, the player assignment manager 118 may limit the number of overlays displayed to users of the virtual environment.

The input receiver 120 can receive, obtain, or otherwise retrieving inputs from the user input device 128. The inputs can be analog movements (e.g., player movement and skill moves), button press (pass, score, cross, through ball), sprints, trigger press, direction pad inputs, keyboard inputs, mouse clicks, among other inputs associated with the user. The inputs can correspond to a movement of at least one player model 302. The movement can indicate that at least one player model 302 was located a first portion of the playable field 134 at first time (e.g., first state 300) and moved to a second portion of the playable field 134 at a later time (e.g., second state). The movement can occur with a player model 302 in possession of the target object 304, a player model 302’ defending, any player model 302 changing locations, among other movements corresponding to a user input.

In some instances, the input receiver 120 can detect, identify, or otherwise indicate a user status for the user. The user status can be at least one of idle, offline, or active. Each user status can be assigned or indicated via the player assignment manager 118. The input receiver 120 can indicate the user status based on at least a delta between the current time and a previous user input or a connection status. For example, a poor connection status can indicate that a user controlling the player model 302 is offline as the internet is not sustainable for the virtual environment 132. In another example, the delta can be greater than a threshold indicating that the input receiver 120 has not received an interaction or input in for a time period. Therefore, the player assignment manager 118 can change the user status from active to idle or detect the change in the user status.

The player assignment manager 118 can generate an indicator 310 relative to the user to indicate the user status. The indicator 310 can be a flag, a marker, a status, among other indications to indicate the change in user status. For example, the change of status from active to idle can provide an exclamation point as the indicator of the player model 302A. In some instances, the player assignment manager 118 can remove the indication 310 in response to the input receiver 120 detecting an input from the user input device 128. The player assignment manager 118 can display the indicator 310 proximal to the player model 302A that is controlled by the idle user within the virtual environment 132.

While the player model 302A includes the indication 310 that the user is idle, the player assignment manager 118 can automatically implement one or more controls for the player model 302A, responsive to the change in the user status. The one or more controls can be basic movements, such as, moving toward a portion 306 of the playable field 134 or passing the target object 304 to a different player model 302. For example, the player assignment manager 118 can control the idle player model 302A to move from a first portion 306 of the playable field 134 to a second portion 306 of the playable field 134. In some instances, the player assignment manager 118 can access the data store 126 or the data store 108 to select the one or more controls from a predefined set of actions for implementation. In this manner, the technical solutions described herein can implement a limited non-user control using significantly fewer computing resources than other solutions which may have an overreliance on artificial intelligence.

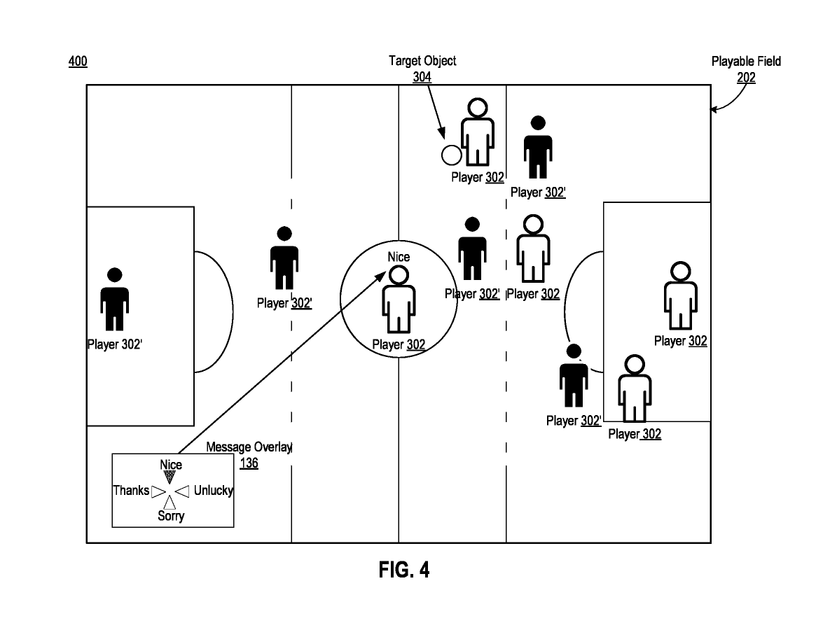

Each movement can include a type for the movement, such as free movement, attacking movement, defending movement, scoring movement, passing movement, among other types of movements. The input receiver 120 can provide the state handler 116 each type of movement upon reception of the user input. The state handler 116 can use the type of movement to determine a second state for the virtual environment 132. For example, a first player model 302’ can move to the portion 306 indicated by the overlay 308. In response to the free movement of the player model 302, the state handler 116 can determine to change from the first state 300 to a second state, responsive to the movement. The second state can differ from the first state as shown in FIG. 4.

Referring now to FIG. 1 and FIG. 4, depicted is an example of the playable field 134 including a message overlay 136 for at least one player model 302 in a second state 400. In some instances, the second state 400 can be the same as the first state 300. In some instances, the second state 400 can be different from the first state 300. The second state 400 can occur in response to the subsequent user input captured by the input receiver 120. The second state 400 can correspond or refer to a movement of at least one or more player models 302, a change in possession, a movement of the target object 304, among others. In response to the user input or determining the second state 400, the state handler 116 can modify, adjust, or otherwise change the first state 300 to the second state 400 to accommodate for the user input. For example, in the first state 300, a first player model 302 can have possession of the target object 304. A user controlling the first player model 302 can pass the target object 304 to a second player model 302 by pressing a button on the user input device 128. The input receiver 120 can provide the button press indicating a pass to the state handler 116. The state handler 116 can modify the first state 300 to the second state 400 indicating that the second player model 302 is in possession of the target object 304.

The second state 400 can include the message overlay 136 based on the possession of the target object 304. In some instances, the first state can include the message overlay 136. The prompt determinator 122 can determine, identify, or otherwise indicate the message overlay 136 for each player model 302. The message overlay 136 can include a plurality of messages communicated to other player models 302 within the virtual environment 132. The plurality of messages can include pass, nice, unlucky, sorry, cross, through, shoot, run, come short, press the ball, among other messages. In some embodiments, the prompt determinator 122 may be configured to select a subset of messages from the plurality of messages, based on the state of the virtual environment (or a change in the state of the virtual environment). For example, the prompt determinator 122 may be configured to select the subset of messages by applying the state(s) to a classification model which maps the game states to corresponding subsets of messages. The message overlay 136 can be presented to the user based on the state of the virtual environment 132 and the assignment of the player model 302. For example, a first team can have possession of the target object 304 and the player model 302 can be assigned with midfield. Based on the assignment, the prompt determinator 122 can determine or configure the message overlay 136 to include pass, thanks, unlucky, and sorry in response to a user input to display the messages. In another example, a first team can have possession of the target object 304 and the player model 302 can be assigned with goalkeeper. Based on the assignment, the prompt determinator 122 can determine or configure the message overlay 136 to include run, come short, and press the ball in response to a user input to display the messages. The virtual environment generator 114 can display, provide, or present the message overlay 136 above the player model 302 based on the determination by the prompt determinator 122 as shown in FIG. 4.

The input receiver 120 can receive or detect a user input corresponding to a selection of at least one prompt in the plurality of prompts according to the first state 300 or the second state 400. The user input can indicate a command that correspond to prompt relative to the player model 302 as shown in FIG. 4. The virtual environment generator 114 may be configured to render a selected message (e.g., based on selection of the user input of a prompt) within the virtual environment. For example, the virtual environment generator 114 may be configured to render the selected messages in each of the instances of the virtual environment, such that each of the users interacting with the virtual environment are able to view the selected message. In some embodiments, the virtual environment generator 114 may be configured to render selected messages within a subset of instances of the virtual environment, based on a corresponding context. For instance, each message may be tagged with a corresponding recipient (e.g., a co-user or opponent). The virtual environment generator 114 may be configured to render selected messages within instances of the virtual environment based on the corresponding tags. For example, the virtual environment generator 114 may be configured to render selected messages in the instance of the virtual environment corresponding to the user that selected the message, and in another virtual environment corresponding to the recipient associated with the tag of the selected message (e.g., in an instance of the virtual environment corresponding to the co-user or in the instance of the virtual environment corresponding to the opponent). In this regard, the virtual environment generator 114 may be configured to render selected messages in a subset of instances (but, in some embodiments, not all instances) of the virtual environment.

In response to modifying the first state 300 to the second state 400, the player assignment manager 118 can update, adjust, or otherwise change the assignment of each player model 302 based on the plurality of factors. For example, the player assignment manager 118 can update the assignment of a first player model 302 based on the movement of the first player model to a different portion 306 of the playable field 134. In another example, the player assignment manager 118 can update the assignment of each player model 302 on a first team based on change in possession of the target object 304. In yet another example, the player assignment manager 118 can update the assignment of each player model 302 based on a plurality of user inputs corresponding to each player model 302. In yet another example, the player assignment manager 118 can update the assignment of at least two player models 302 based on the location of the target object 304 being proximal to each of the at least two player models 302.

In the context of the second state 400, the player assignment manager 118 can assign, indicate, or otherwise identify a second player assignment for each player model 302 according the second state 400 of the virtual environment 132. The assignment can correspond to the position of the player model 302, the location of the player model 302, an optimal location of the player model 302 (e.g., portion 306). The player assignment manager 118 can determine the position of the player model 302 on the team in possession of the target object 304, the location of the player model 302, a formation of the player models 302, among other factors. For example, a first player 302 can be in possession of the target object 304, thereby the player assignment manager 118 can assign the first player 302 as a winger. However, a second player 302’ on the opposing team that is the proximal to the target object 304 can be assigned as the wing back.

The player assignment manager 118 can identify the second player assignment for each player model 302. The second player assignment can be based on the location of the player model 302. For example, a first player model 302 on a team that is not in possession of the target object 304, can be located proximal to the target object 304. Based on the location, the player assignment manager 118 can assign the first player as a full back. As another example, the first player model 302 on a team that is not in possession of the target object 304, can be located in the right side of the playable field 134. Based on the location, the player assignment manager 118 can assign the first player model 302 as a wing back. In some instances, the player assignment manager 118 can configure, assign or otherwise indicate a weight for the player assignment of the player models 302. The weight can be a metric, a value, an indication, or a parameter that is based on whether the player model 302 is user-controlled or non-user controlled (e.g., CPU controlled). For example, the weight can be higher for user-controlled player models 302.

The second player assignment can indicate the second portion 306 of the playable field 134 for at least one player model 302. To direct the at least one player model 302 to the second portion 306, the player assignment manager 118 can generate, create, or otherwise determine a subsequent overlay for display on the playable field 134 (similar to the overlay 308 shown in FIG. 3). The overlay can include one or more user interface elements that are rendered on the display 130. The one or more user interface elements can include a shape to guide the at least one player model 302 to the second portion 306 of the playable field 134. The shape can include a single array, a plurality of arrows, a ray, a line, among other shapes to provide direction to the second portion 306. For example, a first player 302 can be in front of a second player 302 in possession of the target object 304 in the first state 300. The player assignment manager 118 can identify the first player 302 as the left winger. The player assignment manager 118 can generate the overlay 308 to direct the first player model 302 to the second portion 306 of the playable field 134 to be established at the left winger.

The input receiver 120 can receive, obtain, or otherwise retrieve subsequent inputs from the user input device 128. The inputs can be analog movements (e.g., player movement and skill moves), button press (pass, score, cross, through ball), sprints, trigger press, direction pad inputs, keyboard inputs, mouse clicks, among other inputs associated with the user. The inputs can correspond to a movement of at least one player model 302. The movement can indicate that at least one player model 302 was located a second portion of the playable field 134 at a second time (e.g., second state 400) and moved to a third portion of the playable field 134 at a later time (e.g., third state state). The movement can occur with a player model 302 in possession of the target object 304, a player model 302’ defending, any player model 302 changing locations, among other movements corresponding to the user input.

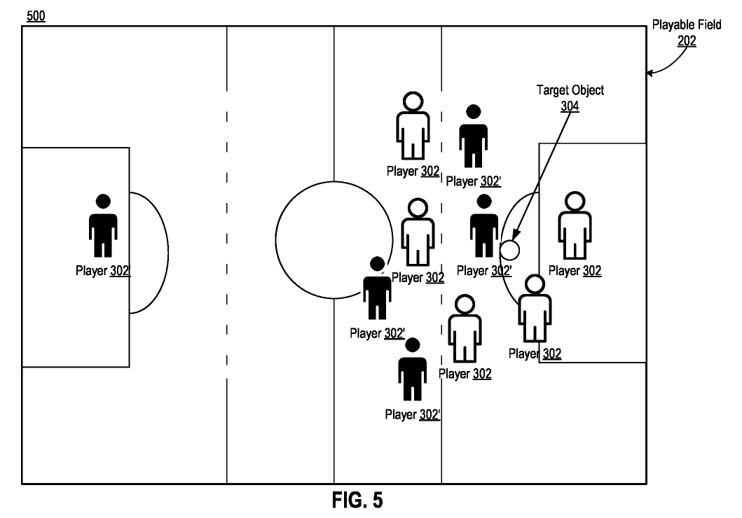

Each movement can include a type for the movement such as free movement, attacking movement, defending movement, scoring movement, passing movement, among other types of movements. The input receiver 120 can provide the state handler 116 each type of movement upon reception of the user input. The state handler 116 can use the type of movement to determine a third state for the virtual environment 132. For example, a first player model 302’ can move to the third portion 306 indicated by the overlay 308. In response to the free movement of the player model 302, the state handler 116 can determine to change from the second state 400 to a third state, responsive to the movement. The third state can differ from the second state as shown in FIG. 5.

Referring now to FIG. 1 and FIG. 5, depicted is an example of the playable field 134 in a third state 500. The third state 500 can be different from the second state 400. The third state 500 can occur in response to the subsequent user input captured by the input receiver 120. The third state 500 can correspond or refer to a movement of at least one or more player models 302, a change in possession, a movement of the target object 304, among others. In response to the user input or determining the third state 500, the state handler 116 can modify, adjust, or otherwise change the second state 400 to the third state 500 to accommodate for the user input. For example, in the second state 400, a first player model 302 can have possession of the target object 304. A user controlling the first player model 302 can pass the target object 304 to a second player model 302 by selecting a button on the user input device 128, however a third player model 302’ can steal the pass. The input receiver 120 can provide the analog movement indicating a steal to the state handler 116. The state handler 116 can modify the second state 400 to the third state 500 indicating that the third player model 302’ is in possession of the target object 304.

The third state 500 can include the message overlay 136 based on the possession of the target object 304, similar to the second state 400 and the first state 300. The prompt determinator 122 can determine, identify, or otherwise indicate the message overlay 136 for each player model 302. The message overlay 136 can include a plurality of messages communicated to other player models 302 within the virtual environment 132. The plurality of messages can include pass, nice, unlucky, sorry, cross, through, shoot, run, come short, press the ball, among other messages. The message overlay 136 can be presented to the user based on the state of the virtual environment 132 and the assignment of the player model 302. For example, a first team can have possession of the target object 304 and the player model 302 can be assigned with left wing. Based on the assignment, the prompt determinator 122 can determine or configure the message overlay 136 to include shoot, cross, through, or run in response to a user input to display the messages. In another example, a first team can have possession of the target object 304 and the player model 302 can be assigned with goalkeeper. Based on the assignment, the prompt determinator 122 can determine or configure the message overlay 136 to include run, come short, and press the ball in response to a user input to display the messages. The virtual environment generator 114 can display, provide, or present the message overlay 136 above the player model 302 based on the determination by the prompt determinator 122. The input receiver 120 can receive or detect a user input corresponding to a selection of at least one prompt in the plurality of prompts according to the first state 300, the second state 400, or third state 500.

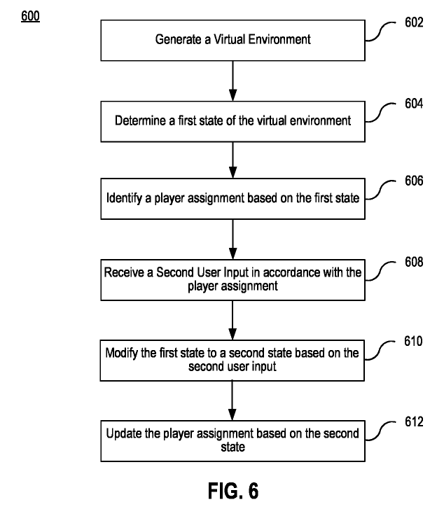

Referring now to FIG. 6, depicted is a flowchart showing an example method 600 of modifying virtual environments, according to an example implementation of the present disclosure. The steps of the method 600 described herein may be executed or performed by the hardware/elements described above with reference to FIG. 1–FIG. 5, such as the interactive computing system 102 and/or the player computing system 104. For example, where a video application is a locally executing video application, the method 600 may be performed by the player computing system 104. Where the video application is a hosted video application, the method 600 may be performed by the interactive computing system 102. Where the video application is a distributed video application, some steps may be performed by the player computing system 104 while other steps may be performed by the interactive computing system 102.

At step 602, the application system 112 may generate a virtual environment 132 (e.g., a virtual game environment). In some embodiments, the application system 112 may generate the virtual game environment responsive to a user launching the application 124, launching game play within the application 124, etc. The virtual environment 132 may include various in-game elements such as terrain, objects, non-player characters (NPCs), and various virtual character models that interact within the virtual environment 132. The application system 112 may generate and/or provide a first player model and a second player model (among other player models) within the virtual environment 132. Each of the player models may be initialized with their respective character metrics stored in the data store(s) 126 and accessible by the application system 112. The player models may be controlled via user inputs and/or pre-programmed/computer determined behavior according to game logic.

The virtual environment 132 can include a field 134 based on the application 124. For example, and as described above with reference to FIG. 2 – FIG. 4, the application 124 can specify that the field 134 is a soccer field. The field 134 can be based on a real-life model of the field 134 (e.g., a virtual soccer field 134 can be based on an actual soccer field 134). The field 134 can include a length 204 and a width 206 that is sized according to a count of player models 302 that are user-controlled or non-user-controlled within the field 134. By using a length of the actual field, the length 204 of the field 134 can be reduced according to a first ratio based on a reduced count of player models 302. By using a width of the actual field, the width 206 of the field 134 can be reduced according to a second ratio based on a reduced count of player models 302. The first ratio can be greater than the second ratio as the length of the field 134 is often greater than the width of the field 134. For example, when the count of the player models 302 is five per team, the first ratio and the second ratio can be between 39–42%.

At step 604, the application system 112 can determine a first state of the virtual game environment 132. The first state can be, for example, a condition, a situation, and/or a status of the virtual environment 132 based on at least one of distance from a target object 304, a movement of one or more player models 302, or a user input from the user input device 128. For example, the first state can indicate that a first team is on offense as a player model 302 on the first team is in possession of the target object 304.

At step 606, the application system 112 can identify an assignment for each player model 302 according to the first state. The assignment can indicate or refer to a position (e.g., offense, defense) for each player model and a portion 306 (e.g., left wing, centerfield, right wing) of the field for at least one player model 302 to occupy. The application system 112 may use and/or receive user inputs from the user input device 128 to determine the portion of the field for the player model to occupy. For example, a user input can move a player model 302 from a first position (e.g., near center field) to a second position (e.g., near opposing team’s goalpost). Based on the change of position, the application system 112 can assign the player model to be a striker and direct the player to a portion 306 of the field. The application system 112 can use the location of each player model 302 within the field 134 to determine the player assignment for each player model 302. For example, a player model 302 that is proximal to the goalpost can be assigned as the goalkeeper and direct the player model 302 to a position that is within/proximate to the goal. The application system can generate an overlay 136 within the field 134 to provide a visual indication directing the player models to occupy the portion 306 based on the player assignment.

At step 608, the application system 112 can receive a subsequent user input from a user. The subsequent user input can be for a movement of the player model to the portion of the field within the field 134 of the virtual environment 132. The movement can be based on an input from the user input device 128. In some instances, the subsequent input can be a command corresponding to a prompt relative to a player model 302. The prompts can be stored within the data store. The command can be a button press to display the prompts of the display 130. The application system 112 can display an overlay including the prompt, adjacent or proximal to the player model 302, and visible to one or more other users in the virtual environment 132. In some instances, the subsequent input can be a selectable field including a subset of the plurality of prompts. Each of the subsets of the plurality of prompts can be based on the respective state of the virtual environment 132.

In some instances, the application system 112 may not receive any subsequent user inputs. The application system 112 can detect a change to a user status and automatically implement one or more controls to a first player model 302 in control by a user, responsive to the change in the user status. The user status can be at least one of active, offline, or idle. To automatically implement the one or more controls, the application system 112 can select, from a set of predefined actions, an action for implementing the one or more controls of the first virtual character model, to implement limited non-user control responsive to the change in the user status. The actions can correspond to free movement, passing of the target objects, or moving toward assigned portions 306 of the field 134. The application system 112 can generate an indicator relative to the user to indicate the user status, responsive to the change in the user status. The application system 112 can provide the indicator for display proximal to the player model 302 in the virtual environment. The indicator 310 can be displayed above the player model 302.

At step 610, the application system 112 can update the player assignment of each player model 302. The update to the player assignment can be based on the movement of at least one player model 302 in the plurality of player models 302. Prior to updating the player assignment, the application system 112 can modify the first state of the virtual environment 132 to the second state of the virtual environment 132. The second state can correspond to a later instance of time than the first state. The application system 112 can identify a second assignment for each player model according to the second state of the virtual environment 132. For example, the second assignment can indicate a second portion of the field 134 for each player model 302 to occupy. The application system 112 can receive another user input for movement of at least one player model to the second portion 306 of the field 134 within the virtual environment 132. From here, the application system 112 can modify the second state of the virtual environment 132 to a third state. In response to the modification, the application system 112 can update the second assignment of each player model 302 based on the movement of the at least one player model 302 according to the user input.

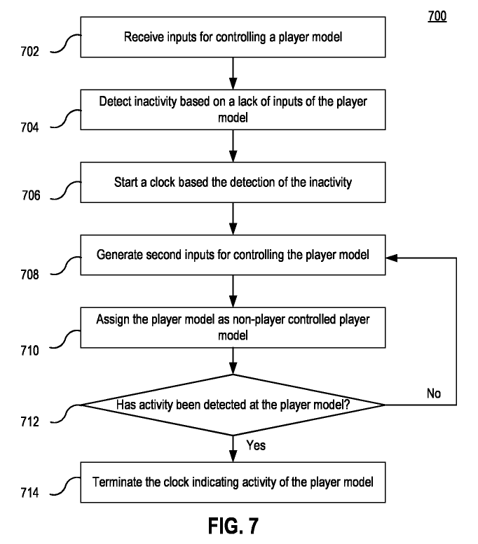

Referring now to FIG. 7, depicted is a flowchart showing an example method 700 of assigning non-user-controlled player models, according to an example implementation of the present disclosure. The steps of the method 700 described herein may be executed or performed by the hardware/elements described above with reference to FIG. 1–FIG. 5, such as the interactive computing system 102 and/or the player computing system 104. For example, where a video application is a locally-executing video application, the method 700 may be performed by the player computing system 104. Where the video application is a hosted video application, the method 700 may be performed by the interactive computing system 102. Where the video application is a distributed video application, some steps may be performed by the player computing system 104 while other steps may be performed by the interactive computing system 102.

At step 702, the application system 112 can receive inputs for controlling a player model (e.g., player model 302). The inputs for controlling a player model can be received by a user input device (e.g., controller, mouse and keyboard, smart device, etc.). For example, a controller can detect shift in position of an analog stick from a leftmost position to a rightmost position. The controller can transmit the detection of the input to the application system 112. Each input can correspond to a change in a state of a virtual environment (e.g., virtual environment 132). The state can indicate a situation, condition, or status of the virtual environment. Each input can reset a timer or a clock which indicates a delta between the previous input. For example, in response to receiving a first input, the application system 112 can start a clock indicating an input associated with the player model. Upon receiving a second input, the application system 112 can reset the clock indicating activity of the player model.

At step 704, and in some embodiments, the application system 112 can detect inactivity based on a lack of inputs of the player model. The inactivity can be indicated based on the clock exceeding a threshold without receiving a subsequent input to the previous input. For example, the application system 112 can detect a first input for controlling a player model and start a clock based on the first input. If the application system 112 does not detect a second input while the clock is below a threshold, the application system 112 can detect inactivity at the player model. In some embodiments, the application system 112 can detect inactivity based on a user switching to a pause screen, stopping play, etc. In some instances, as the clock increases (or the user switches to the pause screen or stops play for a duration), the application system 112 can generate notifications for display on the display (e.g., display 130) for the user interacting with the application 124. The notifications can alert the user of the inactivity by presenting a message, an alert, an indication, among others. Responsive to detecting the inactivity, the application system 112 can generate an indication for display proximal to the player model. The indication can be above the player model.

At step 706, the application system 112 can start/initiate a clock based on the detection of the inactivity. The clock can increase as the application system 112 does not detect interactions for controlling the player model, or the user remaining in the pause screen/stopping play. The clock can be different from the clock or timer described above. The clock can indicate a duration of inactivity for the player model. The application system 112 can display the clock on the display of the user. The application system 112 can update the display based on each iteration of the clock. As the clock increase, the clock can ultimately satisfy (e.g., meet or exceed) a threshold indicating that the user abandoned the video application. For example, after the clock satisfies the threshold, the application system can generate an indication for other player models to indicate that the player model associated with the user has abandoned the video application. Responsive to the abandonment, the application system 112 can replace or modify the player model to correspond to a CPU controlled player model.

At step 708, the application system 112 can generate second inputs for controlling the player model. The second inputs can correspond to inputs generated by the application system 112 or extracted from a data store. The second inputs can correspond to inputs or actions taken by player models. For example, the inputs can include moving from a first location to second location, passing a target object to another player model, defending against another player model, among other actions. The application system 112 can employ or control the player model based on the second inputs while the player model is inactive (e.g., temporarily prior to expiry of the timer described above with reference to step 706, or persistently responsive to expiry of the timer). The second inputs can cause the player model to follow controls generated by the application system 112. At step 710, the application system 112 can assign the player model as a non-player-controlled player model. The assignment of the player model can indicate that the player model is away for the duration of the clock. The assignment of the player model to a non-player-controlled player model can be different from a CPU controlled player model. The non-player-controlled player model can utilize significantly less computing resources thereby improving on the performance of the virtual environment.

At step 712, the application system 112 can determine whether activity is detected by the user to control the player model. The application system 112 can detect a third user input from the player model. The third user input can be for controlling the player model similar to the first inputs. Responsive to detection of the third user input, the application system 112 can indicate that activity is occurring at the player model. The application system 112 can remove the indication of inactivity from the player model. Furthermore, the application system 112 can reset the clocks associated with the detection of activity. From here, the application system 112 can assign the non-player-controlled player model as a player model. If the application system 112 detects the third user input, the method 700 can proceed to step 714. Otherwise, the method can proceed to step 708.

At step 714, the application system 112 can terminate the clock indicating activity of the player model. The application system 112 can remove the indication from the player model to indicate activity. In some instances, the application system 112 can generate a notification to indicate that activity was detected by the player model. The notification can be displayed to each player model within the virtual environment.

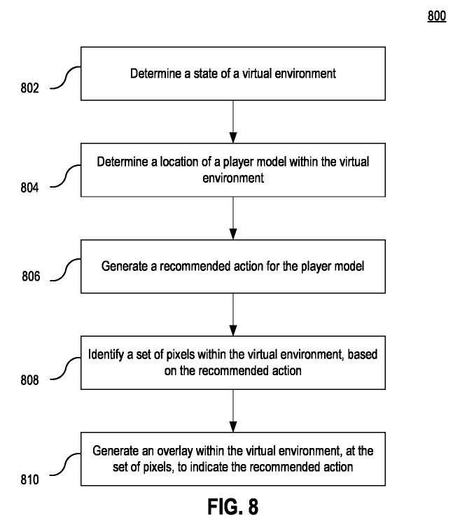

Referring now to FIG. 8, depicted is a flowchart showing an example method 800 of generating overlays for virtual environments, according to an example implementation of the present disclosure. The steps of the method 800 described herein may be executed or performed by the hardware/elements described above with reference to FIG. 1–FIG. 5, such as the interactive computing system 102 and/or the player computing system 104. For example, where a video application is a locally-executing video application, the method 800 may be performed by the player computing system 104. Where the video application is a hosted video application, the method 800 may be performed by the interactive computing system 102. Where the video application is a distributed video application, some steps may be performed by the player computing system 104 while other steps may be performed by the interactive computing system 102.

At step 802, the application system 112 can determine a state of a virtual environment. The state of the virtual environment can be based on user inputs, movement of the player models within the virtual environment, a location of a target object, possession of the target object, among others. The state can correspond to a condition, a status, or an indication of the virtual environment at an instance of time. For example, a first state can correspond to a first player model in possession of the target object at a first time. In another example, a second state can correspond to a second player model moving to a location within the virtual environment at a second time. In another yet example, a third state can correspond to an action (e.g., pass, kick, tackle) of the player model at a third time.

At step 804, the application system 112 can determine a location of a player model within the virtual environment. The location of the player model can be anywhere within a playable field (e.g., playable field 134). The location for the player model can change based on the state of the virtual environment. For example, a first location (e.g., center field) of the player model can trigger a first state of the virtual environment. In another example, a second location (e.g., left wing) can trigger a second state of the virtual environment. To determine the location, the application system 112 can monitor the movement of each player model. The application system 112 can use coordinate system or collision detection systems to continuously determine a player's location. For instance, the application system 112 can use a cartesian coordinate system by mapping a 2D or 3D coordinate system to the playable field. Each player model can be assigned a position within the coordinate system to establish a location of each player model. In some instances, the application system can use transform components, physics engines, collision detection, game logic, game scripting, or grid-based systems, among others.

At step 806, the application system 112 can generate a recommended action for the player model. The recommended action can be based on the location of the player model, the movement of the player model, the state of the virtual environment, and/or user inputs by a user input device. The recommend actions can include moving to a first location, a type of action when in possession of the target object, a position of the player model, among other action to be taken within the virtual environment. The recommended actions can be generated based on a configuration of the application for the user. For example, a first configuration may not allow the application system 112 to generate the overlays for any states of the virtual environment. In another example, a second configuration may allow for the application system 112 to generate overlays on demand by the user or for at least one state of the virtual environment. In yet another example, a third configuration can allow for the application system 112 to generate overlays for a limited time/duration/count of overlays, and/or for certain state(s) of the virtual environment.

At step 808, the application system 112 can identify a set of pixels within the virtual environment based on the recommendation action. The set of pixels can correspond to a recommended location for the player model to perform the recommended action. The recommended location can be a placement for the player model based on the recommended action and an assignment of the player model. The set of pixels can be or include a target region, location, etc. within the playable field, in which to generate a set of overlays. The application system 112 may determine the set of pixels based on the recommended action determined at step 806. For example, where the recommended action is to move a player model diagonally (e.g., forward and to the right), the application system 112 may determine the set of pixels to be pixels located at a location within the playable field of the virtual environment diagonally proximate to the player model (e.g., a portion of pixels forward and to the right of the player model). In some embodiments, to identify the set of pixels, the application system can use the coordinate system to detect the current location of the player model and identify a recommended route for the player model to travel to enter the recommended location and identify pixels around/along/proximate to the recommended route.

At step 810, the application system 112 can generate an overlay within the virtual environment, at the set of pixels, to indicate the recommended action. The application system can generate the overlay within the field to provide a visual indication directing the player models to occupy the portion 306 based on the player assignment. The overlay can be at the set of pixels. For example, the overlay can be an indication, such as colored, highlighted, or encompassed graphical representation of the recommended action. In some embodiments, the overlay can be a translucent overlay which provides for visualization of the underlying virtual environment, with the overlay indicating the recommended action. In some embodiments, the visual indication can include arrows, lines, rays, among other shapes signifying direction. The visual indication can correspond to the route identified by the application system 112.

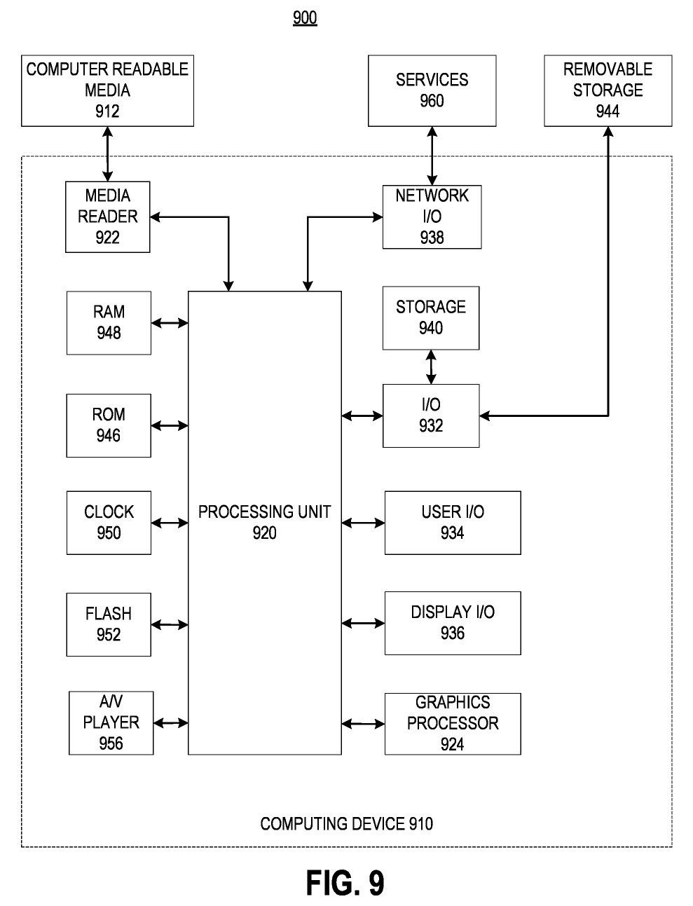

FIG. 9 illustrates an example embodiment of a computing device 910. In some embodiments, some or all of the aforementioned systems and computing devices - such as computing device 102 and 104 of FIG. 1 - are similar to computing device 910. The example computing device 910 can store and/or execute computer executable instructions (or code) of applications (or programs or software), such as video game applications, interactive applications, and/or other applications known to those of skill in the art that could include or benefit from the systems and methods described herein.

Computing device 910 can be or include any one or a combination of systems known to those of skill in the art, including, for example, a desktop, laptop, game application platform, game console, virtual reality system, augmented reality system, television set-top box, television, network-enabled kiosk, car-console devices, computerized appliance, wearable device (e.g., smart watch, glasses with computing functionality), and wireless mobile devices (e.g., smart phones, PDAs, tablets) and other general-purpose computing devices known to those of skill in the art.

As shown, computing device 910 includes processing unit 920 that interacts with other components of the computing device 910 and external components. A media reader 922 communicates with computer readable media 912. The media reader 922 may be an optical disc reader capable of reading optical discs, such as DVDs or Blu Ray discs, or any other type of reader that can receive and read data from computer readable media 912. One or more of the computing devices may be used to implement one or more of the systems disclosed herein.

Computing device 910 may include a graphics processor 924. In some embodiments, the graphics processor 924 is integrated into the processing unit 920, such that the graphics processor 924 may share Random Access Memory (RAM) with the processing unit 920. Alternatively, or in addition, the computing device 910 may include a discrete graphics processor 924 that is separate from the processing unit 920. In some such cases, the graphics processor 924 may have separate RAM from the processing unit 920. Computing device 910 might be a video game console device, a general-purpose laptop or desktop computer, a smart phone, a tablet, a server, or other suitable system for executing software among graphics processor 924, such as a video game application.

Computing device 910 also includes various components for enabling input/output, such as an I/O 932, a user I/O 934, a display I/O 936, and a network I/O 938. I/O 932 interacts with storage element 940 and removable storage media 944 to provide storage for computing device 910. Processing unit 920 can communicate through I/O 932 to store data. In addition to storage 940 and removable storage media 944, computing device 910 is also shown including ROM (Read-Only Memory) 946 and RAM 948. RAM 948 may be used for data that is accessed frequently during execution of software.

User I/O 934 is used to send and receive commands between processing unit 920 and user devices, such as keyboards or game controllers. In some embodiments, the user I/O can include a touchscreen. The touchscreen can be a capacitive touchscreen, a resistive touchscreen, or other type of touchscreen technology that is configured to receive user input through tactile inputs from the user. Display I/O 936 provides input/output functions that are used to display images. Network I/O 938 is used for input/output functions for a network (e.g., receiving and sending network data communications). Network I/O 938 may be used during execution of software applications by computing device 910; such as when a video game application communicates with a game server over a network.

Display output signals produced by processing unit 920 and/or graphics processor 924 can be sent to display by display I/O 936, including signals for displaying visual content produced by computing device 910; such as display output rendered by a video game application, including graphics, GUIs, video, and/or other visual content. Computing device 910 may comprise one or more integrated displays configured to receive display output signals produced by display I/O 936. According to some embodiments, display output signals produced by display I/O 936 may also be output to one or more display devices external to computing device 910, such a display 16.

The computing device 910 can also include other features, such as a clock 950, flash memory 952, and other components. An audio/video player 956 might also be used to play a video sequence, such as a movie or other media as known to those of ordinary skill in the art. An audio/video player 956 may include or use software for encoding or decoding media for playback.

Computer executable instructions, applications, programs, or code (e.g., software) can be stored in ROM 946, RAM 948, media 912, and/or storage 940 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 940, and/or on removable media such as media 912 (which can be a CD-ROM, cartridge, memory chip or the like, or obtained over a network or other electronic channel as needed). In general, applications can be found embodied in a tangible non-transitory signal-bearing medium.

Random access memory (RAM) 948 (and possibly other storage) is usable to store variables and other processor data as needed. RAM is used and holds data that is generated during the execution of an application and portions thereof might also be reserved for frame buffers, application state information, and/or other data needed or usable for interpreting user input and generating display outputs. Generally, RAM 948 is volatile storage and data stored within RAM 948 may be lost when the computing device 910 is turned off or loses power.

As computing device 910 reads media 912 and provides an application, information may be read from media 912 and stored in a memory device, such as RAM 948. Additionally, data from storage 940, ROM 946, services 960 accessed via a network (not shown), or removable storage media 946 may be read and loaded into RAM 948. Although data is described as being found in RAM 948, it will be understood that data does not have to be stored in RAM 948 and may be stored in other memory accessible to processing unit 920 or distributed among several media, such as media 912 and storage 940.

The disclosed subject matter can include an apparatus for performing the operations herein. This apparatus may be specially constructed for the required purposes, or it may comprise a general-purpose computer selectively activated or reconfigured by an application stored and/or executed by computing device 910. Such an application may be stored in a non-transitory computer readable medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The disclosed subject matter may include a non-transitory computer readable medium having stored thereon applications or instructions, which may be used (e.g., executed) to instruct a system or computing devices to perform a process according to the disclosed subject matter. A non-transitory computer readable medium includes any mechanism for storing or transmitting information in a form readable by a computing device and other systems of the like known to those of skill in the art.

The applications or instructions of computing device 910 can be stored and/or executed among a local environment and/or among in a distributed environment of computing devices, as known to those of skill in the art. Different applications can include varying instructions, components, graphical configurations, and/or data for supporting their runtime execution on different hardware (e.g., different types of computing devices).

A locally executed application does not rely on or use an external computing device (e.g., a system other than computing device 910) to execute the application. In some instances, a locally executable video game application can communicate with external systems or devices, such as external servers, to retrieve information associated with the video game, such as game patches, game authentication, cloud saves, user account data, previously trained model data, or other features.

In distributed implementations, computing device 910 may execute portions of a video game application, while other systems or devices such as external servers execute other portions of the video game application. For instance, massively multiplayer online role-playing games (MMORPGs) include client portions (e.g., video game application) of the video game executed by computing devices of or corresponding to users or players, and server portions executed by one or more servers. It should be understood that applications described herein can be a locally executable game or a distributed application.

Graphics processor 924, or graphics processing unit (GPU), can perform processing tasks associated with rendering images, graphics, and visual content, in addition to machine learning tasks. A GPU commonly comprises multiple processing cores that execute operations in parallel, optimizing performance for tasks such as 3D rendering, texture mapping, shading, and real-time physics simulations. In addition to dedicated rasterization units, shading engines, and ray-tracing cores, a GPU may include high-bandwidth memory (VRAM) and support for general-purpose computing, enabling it to handle computational workloads beyond graphics, including scientific simulations, cryptography, and machine learning and/or neural network processing. GPUs can operate as discrete hardware components or as integrated units within system-on-chip (SoC) architectures, often interfacing with CPUs, memory controllers, and high-speed interconnects for efficient data processing.

As known to a person of ordinary skill in the art, modern GPUs increasingly incorporate dedicated machine learning hardware, such as tensor cores, matrix multiplication units, and neural processing units (NPUs), which accelerate deep learning inference, neural network training, and AI-driven rendering techniques. These specialized components enhance real-time upscaling, denoising, adaptive shading, as well as neural-based image, frame, video, and audio reconstruction, among other things, allowing for more efficient and high-fidelity visual output. Accordingly, it is appreciated that GPUs can be configured to enable the execution of neural rendering models, physics-based simulations, and real-time generative AI applications, in addition to the systems and methods described herein.

The present disclosure may use machine learning. Machine learning is a subfield of artificial intelligence, which, to persons of ordinary skill of the art, corresponds to underlying algorithms and/or frameworks (commonly known as “neural networks” or “machine learning models”) that are configured and/or trained to perform and/or automate one or more tasks or computing processes. For simplicity, the terms “neural networks” and “machine learning models” can be used interchangeably and can be referred to as either “networks” or “models” in short.

The present disclosure may use deep learning. Deep learning is a subfield of artificial intelligence and machine learning, which, to persons of ordinary skill of the art, corresponds to multilayered implementations of machine learning (commonly known as “deep neural networks”). For simplicity, the terms “machine learning” and “deep learning” can be used interchangeably.

As known to a person of ordinary skill in the art, machine learning is commonly utilized for performing and/or automating one or more tasks such as identification, classification, determination, adaptation, grouping, and generation, among other things. Common types (e.g., classes or techniques) of machine learning include supervised, unsupervised, regression, classification, reinforcement, and clustering, among others.

Among these machine learning types are a number of model implementations, such as linear regression, logistic regression, evolution strategies (ES), convolutional neural networks (CNN), deconvolutional neural networks (DNN), generative adversarial networks (GAN), recurrent neural networks (RNN), mixture-of-experts (MoE), transformers, support vector machines (SVM), Bayesian networks, k-nearest neighbors (KNN), decision trees, gradient boosting machines (GBM), autoencoders, long short-term memory networks (LSTM), reinforcement learning models (RL), imitation learning models (IL), and random forest, among others. As known to a person of ordinary skill in the art, one or more machine learning models can be configured and trained for performing one or more tasks during runtime of a machine learning module.

As known to a person of ordinary skill in the art, the output of a machine learning model is based at least in part on its type, implementation, configuration, and/or training data. The data that models are trained on (e.g., training data) can include one or more data types. In some embodiments, the training data of a model can be changed, updated, and/or supplemented throughout training and/or inference (i.e., runtime) of the model.

The systems, methods, and/or computing devices of the present disclosure can include machine learning modules. A “machine learning module” is a software module and/or hardware module including computer-executable instructions to configure, train, and/or deploy (e.g., execute) one or more machine learning models.

Some aspects of the present disclosure include subject matter corresponding to the gameplay of video game applications. As known to a person of ordinary skill in the art, the gameplay of a video game is commonly known as occurring among a game session within one or more instances of one or more virtual interactive environments. The gameplay of a video game provides interactivity with one or more aspects of a video game.

A game session may include a number of player characters and/or non-player characters. As known to those of skill in the art, player characters are character models that can be controlled or directed (at least primarily) by users or players through inputs at their respective computing devices and can perform gameplay actions or commands. “Non-player characters” (also referred to herein as “NPCs”) are characters that are not or cannot be controlled and/or directed (primarily by users or players). Rather, NPCs can be configured with computer executable instructions to perform one or more gameplay tasks and/or actions, with and/or without the need for input or interaction from a user/player or player character.

A game session may include a number of player objects. Player objects can refer to controllable objects, or models, used to facilitate or enable gameplay or other in-game actions. Player objects may be, for example, vehicles, vessels, aircraft, ships, tiles, cards, dice, pawns, and other in-game items of the like known to those of skill in the art. In some embodiments, a user or player can control or direct one or more player objects in a game session, including, in some instances, by controlling player characters which in turn cause the objects to be controlled.

For simplicity, player characters and player objects disclosed are collectively referred to herein as player characters in some embodiments. It should be understood that, as used herein, “controllable” refers to the characteristic of being able and/or configured to be controlled and/or directed (e.g., moved, modified, etc.) by a player or user through one or more input means, such as a controller or other input device, by a player or user. As known to a person of ordinary skill in the art, player characters include character models configured to receive input.

Some aspects of the present disclosure include subject matter corresponding to data of video game applications. As known to a person of ordinary skill in the art, data of a video game application can include data such as state data, simulation data, rendering data, digital assets, and other data of the like.

State data is commonly known as data describing a state of a player character, virtual interactive environment, and/or other virtual objects, actors, or entities - in whole or in part - at one or more instances or periods of time during a game session of a video game. For example, state data can include the current location and condition of one or more player characters among a virtual interactive environment at a given time, frame, or duration of time or number of frames.

State data can be simulated and/or generated by a simulator of a video game engine to produce simulation data. Simulation data, or state simulation data, is commonly known as the underlying data corresponding to the simulated aspects (e.g., physics and other corresponding mechanics) to drive simulation of a model or object in a game engine. For example, simulation data can include the joint and structural configuration of a character model and corresponding physical forces or characteristics applied to it at instance or period of time during gameplay, such as a “frame”, to create animations, among other things. Accordingly, simulation data can correspond to the positioning, movements, and/or animation of objects and/or characters in a video game.

Render Data is commonly known as the underlying data corresponding to rendering (e.g., visual, and auditory rendering) aspects of a game session, which are rendered (e.g., for output to an output device) by a game engine. For example, render data can include data corresponding to the rendering of graphical, visual, auditory, and/or haptic output of a video game, among other things.

Game assets (or assets in short) can include virtual objects, character models, actors, entities, geometric meshes, textures, terrain maps, animation files, audio files, digital media files, font libraries, visual effects, and other digital assets of the like commonly used in video games.

In some embodiments, a game session or gameplay is based in part on the data of a video game. One or more aspects of gameplay (e.g., rendering, simulation, state, gameplay actions of player characters) uses, produces, generates, and/or modifies game data. Likewise, gameplay events, objectives, triggers, and other aspects, objects, or elements of the like also use, produce, generate, and/or modify data of a video game.

The data of a video game may be updated, versioned, and/or stored periodically as a number of files to a computing device. Additionally, game data, or copies and/or portions thereof, can be stored, referenced, categorized, or placed into a number of buffers or storage buffers. A buffer can be configured to capture particular data, or data types, of game data for processing and/or storage.

Some aspects of the present disclosure include subject matter corresponding to video games, including video game components corresponding to the software of a video game. As known to a person of ordinary skill in the art, game code is software defining the gameplay, features, and aspects of a video game whereas a game engine provides underlying frameworks and software that support and facilitate execution of the game code (e.g., gameplay)

As a non-limiting descriptive example, a game engine includes, among other things, a renderer, simulator, and stream layer. A game engine uses game data (e.g., state data, render data, simulation data, audio data, and other data types of the like) to generate and/or render one or more outputs (e.g., visual output, audio output, and haptic output) for one or more computing devices. In some embodiments, a game engine is a distributable computer executable runtime portion of development software, such as a video game development engine.

A renderer is a graphics framework that manages the production of graphics corresponding to lighting, shadows, textures, user interfaces, and other effects to game assets of the like among a game engine. A simulator refers to a framework that manages simulation aspects corresponding to physics and other corresponding mechanics used in part for animations and/or interactions of gameplay objects, entities, characters, lighting, gases, and other game assets or effects of the like. A stream layer is a software layer that allows a renderer and simulator to execute independently of one another among a game engine by providing a common execution stream for renderings and simulations to be produced and/or synchronized (e.g., scheduled) at and/or during runtime.

A game engine also includes an audio engine or audio renderer that produces and synchronizes audio playback with or among the common execution of a stream layer. For example, an audio engine of a game engine can use game data to produce audio output and/or haptic output from game data.

As used herein in some embodiments, video game applications can also use and/or include Software Development Kits (SDKs), Application Program Interfaces (APIs), Dynamically Linked Libraries (DLLs), and other software libraries, components, modules, shims, or plugins that provide and/or enable a variety of functionality; such as - but not limited to - graphics, audio, font, or communication support, establishing and maintaining service connections, performing authorizations, and providing anti-cheat and anti-fraud monitoring and detection, among other things.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an example embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media may be any available media that may be accessed by a general purpose or special purpose computer or other machine with a processor. By way of example, such machine-readable media may comprise RAM, ROM, EPROM, EEPROM, or other optical disk storage, magnetic disk storage or other magnetic storage devices, or any other medium which may be used to carry or store desired program code in the form of machine-executable instructions or data structures and which may be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/-10% from the given measurement, unit, or range unless explicitly indicated otherwise. Coupled elements may be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. A reference to “at least one of ‘A’ and ‘B’” may include only ‘A’, only ‘B’, as well as both ‘A’ and ‘B’. Such references used in conjunction with “comprising” or other open terminology may include additional items.

Modifications of described elements and acts such as variations in sizes, dimensions, structures, shapes and proportions of the various elements, values of parameters, mounting arrangements, use of materials, colors, orientations may occur without materially departing from the teachings and advantages of the subject matter disclosed herein. For example, elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other example embodiments, and that such variations are intended to be encompassed by the present disclosure.

Some portions of the detailed descriptions above are presented in terms of symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated (e.g., among a computing device). It has proven convenient at times, principally for reasons of common usage, to refer to these signals as bits, values, elements, symbols, characters, terms, numbers, or the like.

Certain example embodiments are described above to provide an overall understanding of the principles of the structure, function, manufacture and use of the devices, systems, and methods described herein. One or more examples of these embodiments are illustrated in the accompanying drawings. Those skilled in the art will understand that the descriptions herein and the accompanying drawings are intended to be illustrative, and not restrictive. Many other implementations will be apparent to those of skill in the art based upon the above description. Such modifications and variations are intended to be included within the scope of the present disclosure. The scope of the present disclosure should, therefore, be considered with reference to the claims, along with the full scope of equivalents to which such claims are entitled. The features illustrated or described in connection with one exemplary embodiment may be combined with the features of other embodiments. In some instances, well-known structures and devices are shown in block diagram form, rather than in detail, in order to avoid obscuring the disclosed subject matter.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user’s privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A system, comprising:
a data store comprising application data; and
a processing circuit comprising one or more processors configured to execute an application, based at least in part on the application data, the one or more processors configured to:
generate a virtual environment having a field sized according to a count of a plurality of virtual character models which are configured for control within the field;
determine a first state of the virtual environment based on at least one of a first user input, a location of each virtual character model with the field, or the location of a target object proximal to each virtual character model within the field;
identify an assignment for each virtual character model according to the first state of the virtual environment, the assignment indicating a portion of the field for each virtual character model;
receive a second user input for movement of at least one virtual character model to the portion of the field within the virtual environment; and
responsive to modifying the first state of the virtual environment to a second state, update the assignment of each virtual character model based on the movement of the at least one virtual character model of the plurality of virtual character models.

2. The system of claim 1, wherein the one or more processors configures a weight for assignment of each virtual character model based on whether a respective virtual character model is user-controlled or a non-user controlled.

3. The system of claim 1, wherein the field has a length and a width, wherein the length is reduced at a first ratio according to a reduction in the count of virtual character models, and the width is reduced at a second ratio, wherein the first ratio is greater than the second ratio.

4. The system of claim 3, wherein when the count is five, the first ratio and the second ratio are between 39% and 42%.

5. The system of claim 1, wherein the one or more processors are configured to generate, according to the first state, an overlay within the field indicating the portion of the field for the at least one virtual character model to occupy based on the assignment.

6. The system of claim 1, the one or more processors are configured to detect a change to a user status and automatically implement one or more controls to a first virtual character model in control by a user, responsive to the change in the user status.

7. The system of claim 6, the one or more processors are configured to select, from a set of predefined actions, a first action for implementing the one or more controls of the first virtual character model, to implement limited non-user control responsive to the change in the user status.

8. The system of claim 6, the one or more processors are configured to:
generate an indicator relative to the user to indicate the user status, responsive to the change in the user status; and
provide the indicator for display proximal to the first virtual character model in the virtual environment.

9. The system of claim 1, the one or more processors are configured to:
receive a third user input from a first user, indicating a command corresponding to a prompt relative to a first virtual character model; and
display an overlay including the prompt, adjacent to the first virtual character model, the overlay and the prompt being displayed visible to at least one or more second users.

10. The system of claim 9, wherein the third user input is to a selectable field including a subset of a plurality of prompts, each prompt in the subset of prompts selected from the plurality of prompts based on the first state or the second state.

11. The system of claim 1, the one or more processors are configured to:
identify a second assignment for each virtual character model according to the second state of the virtual environment, the second assignment indicating a second portion of the field for each virtual character model;
receive a third user input for movement of at least one virtual character model to the second portion of the field within the virtual environment; and
responsive to modifying the second state of the virtual environment to a third state, update the second assignment of each virtual character model based on the movement of at least one virtual character model according to the third user input.

12. A method, comprising:
generating, by one or more processors, a virtual environment having a field sized according to a count of a plurality of virtual character models which are configured for control within the field;
determining, by the one or more processors, a first state of the virtual environment based on at least one of a user input, a location of each virtual character model with the field, the location of a target object proximal to each virtual character model within the field;
identifying, by the one or more processors, an assignment for each virtual character model according to the first state of the virtual environment, the assignment indicating a portion of the field for each virtual character model;
receiving, by the one or more processors, a second user input for movement of at least one virtual character model to the portion of the field within the virtual environment; and
responsive to modifying the first state of the virtual environment to a second state, updating, by the one or more processors, the assignment of each virtual character model based on the movement of the at least one virtual character model of the plurality of virtual character models.

13. The method of claim 12, further comprising configuring, by the one or more processors, a weight for assignment of each virtual character model based on whether a respective virtual character model is user-controlled or a non-user controlled.

14. The method of claim 12, wherein the field has a length and a width, wherein the length is reduced at a first ratio according to a reduction in the count of virtual character models, and the width is reduced at a second ratio, wherein the first ratio is greater than the second ratio, wherein when the count is five, the first ratio and the second ratio are between 39% and 42%.

15. The method of claim 12, further comprises generating, by the one or more processors according to the first state, an overlay within the field indicating the portion of the field for the at least one virtual character model to occupy based on the assignment.

16. The method of claim 12, further comprises detecting, by the one or more processors, a change to a user status and automatically implement one or more controls to a first virtual character model in control by a user, responsive to the change in the user status.

17. The method of claim 16, further comprises selecting, by the one or more processors from a set of predefined actions, a first action for implementing the one or more controls of the first virtual character model, to implement limited non-user control responsive to the change in the user status.

18. The method of claim 16, further comprising:
generating, by the one or more processors, an indicator relative to the user to indicate the user status, responsive to the change in the user status; and
providing, by the one or more processors, the indicator for display proximal to the first virtual character model in the virtual environment.

19. The method of claim 12, further comprising:
receiving, by the one or more processors from a first user, a third user input indicating a command corresponding to a prompt relative to a first virtual character model; and
displaying, by the one or more processors, an overlay including the prompt, adjacent to the first virtual character model, the overlay and the prompt being displayed visible to at least one or more second users.

20. A non-transitory computer readable medium containing instructions executable by one or more processors, the instructions cause the one or more processors to:
generate a virtual environment having a field sized according to a count of a plurality of virtual character models which are configured for control within the field;
determine a first state of the virtual environment based on at least one of a first user input, a location of each virtual character model with the field, or the location of a target object proximal to each virtual character model within the field;
identify an assignment for each virtual character model according to the first state of the virtual environment, the assignment indicating a portion of the field for each virtual character model;
receive a second user input for movement of at least one virtual character model to the portion of the field within the virtual environment; and
responsive to modifying the first state of the virtual environment to a second state, update the assignment of each virtual character model based on the movement of the at least one virtual character model of the plurality of virtual character models.
